(19) United States
(12) Patent Application Publication
(10) Pub. No.: US 2003/0231427 A1
(43) Pub. Date: Dec. 18, 2003

(54) Magnetic disk cartridge

(75) Inventor: Junichi Nakamikawa, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/460,400

(22) Filed: Jun. 13, 2003

(30) Foreign Application Priority Data
Jun. 13, 2002 (JP) 2002-172225

(51) Int. Cl. G11B 23/03

(52) U.S. Cl. 360/133

(57) ABSTRACT

In order to increase a recording capacity of a magnetic disk cartridge without enlarging an area of a flat surface, two magnetic disk media 14 and 15 are contained in a housing which includes half shells 11 and 12 in the magnetic disk cartridge 10 by fixedly attaching the magnetic disc media 14 and 15 to a center core 13 so as to be held thereby.

### BACKGROUND OF THE INVENTION

1. Field of the Invention

The present invention relates to a magnetic disk cartridge in which a discoid magnetic disk medium is contained in a case.

2. Description of the Related Art

Conventionally, a flexible disk has been provided as a type of magnetic disk media. The flexible disk is capable of magnetically recording a signal on magnetic layers thereof which are formed on both sides of a discoid base made of a flexible polyester sheet and the like, by use of a magnetic head.

This flexible disk typically has a hard center core mounted in a center portion of the disk. The flexible disk has been provided as a magnetic disk cartridge of which the entirety thereof is contained in either a plastic or metal shell. Since the flexible disk has advantages in that it is inexpensive to produce and easy to handle, the flexible disk has been mainly used as a recording medium for computers.

Incidentally, an increase in a recording capacity has been constantly demanded for the magnetic disk cartridge.

Improvements in track density and density of recording lines (increases in the numbers of TPI and BPI) are examples of means for increasing the recording capacity of the magnetic disk cartridge. However, if the numbers of TPI and BPI were excessively increased for the magnetic disk media, the magnetic disk media would be easily affected by a change in a floating state of a magnetic head when recording and reproducing data. Consequently, there is a risk that reliability of the data will be lost, and there would inevitably be a limitation on the degree of increases in the number of TPI and BPI.

In addition, enlargement of a recording area of the magnetic disk media is another effective means for increasing the recording capacity. Since members such as the center core are mounted inside an inner circle area in a discoid magnetic disk, it is hard to enlarge the recording area in the inner circle area. The recording area hardly increases in accordance with an increase in the radius of the inner circle area. Thus, for enlargement of the recording area, it is effective to increase the radius of the outer circle area of the recording area by increasing the outer circumference of the magnetic disk. However, due to the increase in the outer circumference of the magnetic disk, it is required to enlarge an area of a flat surface of a cartridge which incorporates this magnetic disk. Accordingly, there is a problem of losing portability and utility of the cartridge if the area of the flat surface is extremely enlarged.

### SUMMARY OF THE INVENTION

The present invention has been developed in consideration of the above-described problems. It is an object of the present invention to provide a magnetic disk cartridge of which recording capacity has been increased without enlarging the area of a flat surface thereof.

The magnetic disk cartridge of the present invention includes a rotatable magnetic disk medium, a housing and a shutter member. The housing contains the magnetic disk medium and is provided with an opening portion for a recording/reproducing head of a recording/reproducing device to access the magnetic disk medium. The shutter member is movable so as to open/close the opening portion. The shutter member is moved by a shutter opening/closing member of the recording/reproducing device to a position where the opening portion is opened upon insertion of the magnetic disk cartridge into the recording/reproducing device. A plurality of magnetic disk media -are contained in the housing.

According to the magnetic disk cartridge of the present invention, by having the plurality of magnetic disk media contained in the housing, it is possible to increase the recording capacity of the magnetic disk cartridge in proportion to the number of the disks without enlarging the area of the flat surface of the cartridge.

### BRIEF DESCRIPTION OF THE DRAWINGS

FIG. 1 is a schematic diagram of a magnetic disk cartridge according to an embodiment of the present invention.

FIG. 2 is a schematic diagram of when the above magnetic disk cartridge is at a shutter opening position.

FIG. 3 is a structural diagram of the above magnetic disk cartridge.

FIG. 4 is a sectional view of the above magnetic disk cartridge.

FIG. 5 is a front view of a magnetic disk drive which is compatible with the above magnetic disk cartridge.

FIG. 6 is a sectional view of the above magnetic disk drive.

### DESCRIPTION OF THE PREFERRED EMBODIMENTS

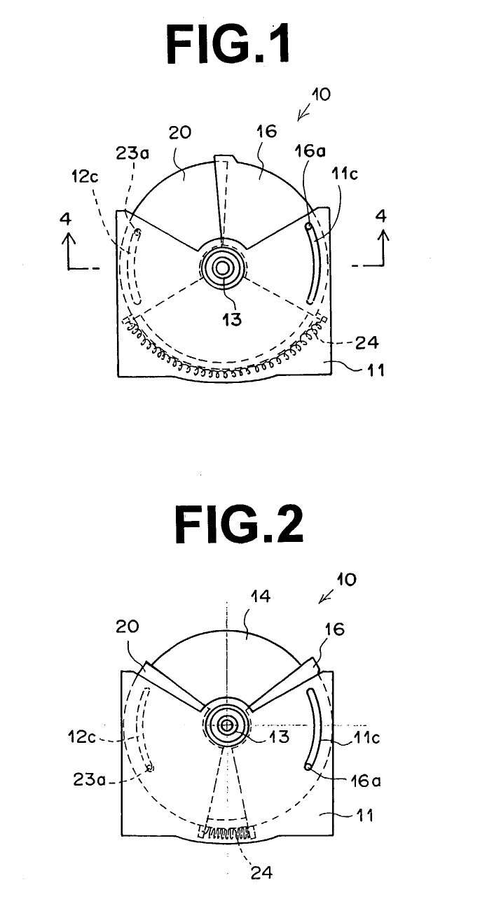

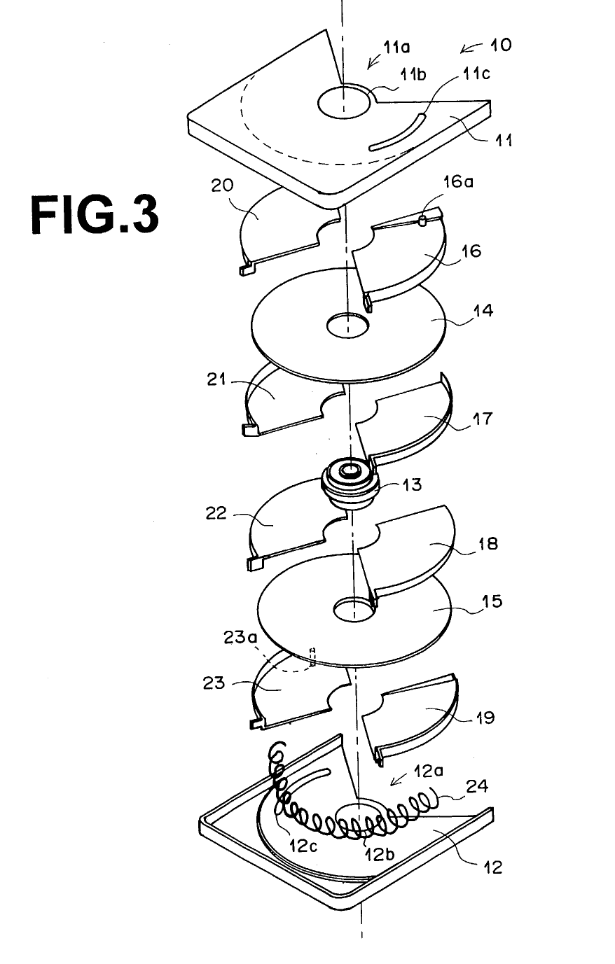

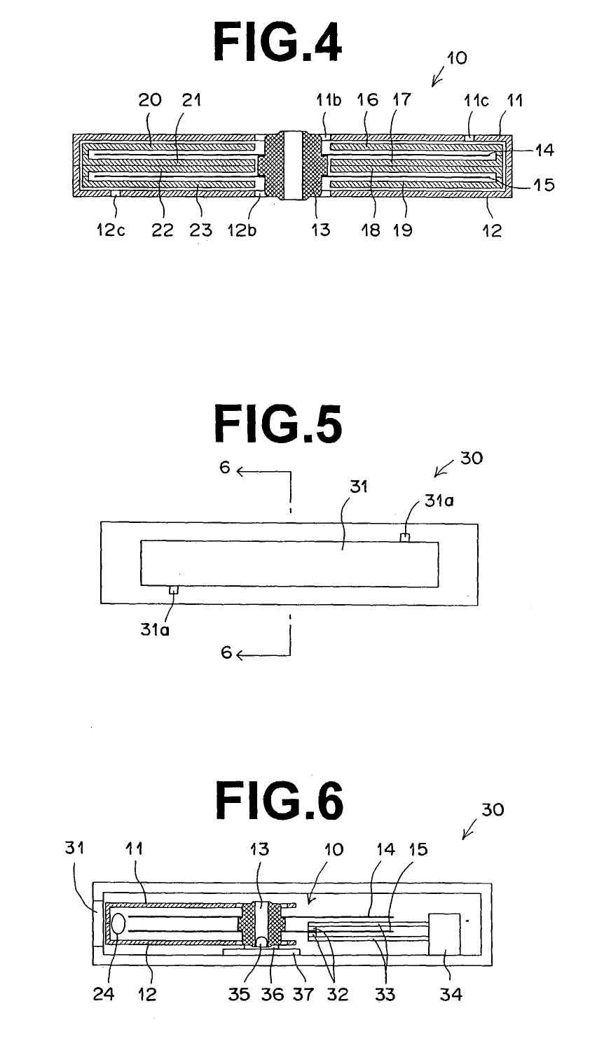

The present invention will be detailed below based on an embodiment illustrated in figures. FIG. 1 is a schematic diagram of a magnetic disk cartridge according to an embodiment of the present invention. FIG. 2 is a schematic diagram of when the magnetic disk cartridge is at a shutter opening position. FIG. 3 is a structural diagram of the magnetic disk cartridge. FIG. 4 is a sectional view of the magnetic disk cartridge.

The magnetic disk cartridge 10 comprises a flat housing composed of first and second half shells 11 and 12. The flat housing contains magnetic disk media 14 and 15, a first shutter member, a second shutter member, a spring 24 and the like. The magnetic disk media 14 and 15 are fixedly attached to and held by a center core 13. The first shutter member includes components 16, 17, 18 and 19. The second shutter member includes components 20, 21, 22 and 23. The spring 24 urges the first and second shutter members to the direction of a closed position.

The first shutter member is structured such that the magnetic disk medium 14 is sandwiched between the components 16 and 17 and the magnetic disk medium 15 is sandwiched between the components 18 and 19. A shutter knob 16a is fixedly attached to the component 16.

Similar to the first shutter member, the second shutter member is structured such that the magnetic disk medium 14 is sandwiched between the components 20 and 21 and the magnetic disk medium 15 is sandwiched between the components 22 and 23. A shutter knob 23a is fixedly attached to the component 23.

When the first and second shutter members are at the closed position, the first shutter member partially overlaps with the second shutter member, thereby preventing dust from entering the magnetic disk cartridge upon conveyance of the cartridge.

The first half shell 11 is provided with a magnetic head insertion portion 11a, an opening portion 11b and an opening portion 11c. The magnetic head insertion portion 11a enables a magnetic head of a recording/reproducing section, which is included in the magnetic disk drive described later, to access the magnetic disk media 14 and 15 by partially exposing the magnetic disk media 14 and 15. The opening portion 11b is for inserting a spindle shaft and the like provided in a drive. The opening portion 11c enables the shutter knob 16a to be movable.

Similar to the first half shell 11, the second half shell 12 is provided with a magnetic head insertion portion 12a, an opening portion 12b and an opening portion 12c. The magnetic head insertion portion 12a enables the magnetic head of the recording/reproducing portion, which is included in the magnetic disk drive described later, to access the magnetic disk media 14 and 15 by partially exposing the magnetic disk media 14 and 15. The opening portion 12b is for inserting the spindle shaft and the like provided in the drive. The opening portion 12c enables the shutter knob 23a to be movable.

Opening/closing of the first and second shutter members are automatically performed as described below when the magnetic disk cartridge 10 is inserted into/removed from the drive.

Accompanied by insertion of the magnetic disk cartridge 10 into the drive, the shutter knobs 16a and 23a respectively fixedly attached to the first and second shutter members are engaged by engaging members in the drive. Further insertion of the magnetic disk cartridge 10 causes the shutter knobs 16a and 23a to move downward in FIG. 1, relative to the housing. Accordingly, the first and second shutter members are respectively moved by rotation to the open position shown in FIG. 2. Consequently, the magnetic disk media 14 and 15 will be in an exposed state.

When removing the magnetic disk cartridge 10 from the drive, since the first and second shutter members are urged to the direction of the closed position by the spring 24, the first and second members are moved to the closed position with the steps in reverse order of steps described above.

The magnetic disk cartridge 10 constituted as described above is structured such that either of the first and second half shells 11 and 12 can be on the upper side to have the same configuration. Therefore, the magnetic disk cartridge 10 can be inserted into the magnetic disk drive which is compatible with this magnetic disk cartridge 10 with either of the first and the second half shell 11 and 12 on the upper side.

Next, the magnetic disk drive which is compatible with the magnetic disk cartridge 10 will be described. FIG. 5 is a front view of the magnetic disk drive which is compatible with the magnetic disk cartridge 10. FIG. 6 is a sectional view of the magnetic disk drive.

The magnetic disk drive 30 is provided with a recording/reproducing section which records and reproduces a signal on either the magnetic disk medium 14 or 15 incorporated into the magnetic disk cartridge 10 and a magnetic disk driving section for driving the rotations of the magnetic disk media 14 and 15. Moreover, cutouts 31a are provided at a magnetic disk cartridge insertion entrance 31 of this magnetic disk drive 30 so that the shutter knobs 16a and 23a provided on the magnetic disk cartridge 10 do not interfere with the magnetic disk cartridge insertion entrance 31 during insertion, when the shutter is in the closed position.

The recording/reproducing section is provided with a pair of suspension members 33 and magnetic heads 32. The pair of suspension members 33 are provided for the upper and lower surfaces of the magnetic disk medium, which is on the lower side of the magnetic disk cartridge 10 inserted into the drive. The magnetic heads 32 are attached to the tip of the suspension members 33.

The magnetic heads 32 are each provided with a slider, and the slider is structured such that a thin film magnetic head having a recording/reproducing head gap and the like are fixedly attached to a part of the slider. According to its design, the above slider produces pressure that causes it to float from the surface of the magnetic disk medium or pressure causing it to be attracted to the surface of the magnetic disk medium by an air stream generated by the rotation of the magnetic disk media. The slider approaches and moves away from the surfaces of the magnetic disk medium in accordance with the high-speed rotation of the magnetic disk medium. Thereafter, contact load of the magnetic head 32 is set at a predetermined value based on the relationship between the design of the slider and the spring forces of the suspension members 33.

The upper and lower suspension members 33 are held by a suspension supporting portion 34. The suspension supporting portion 34 rotates in both directions such that the magnetic heads 32, which are held by the suspension members 33, are movable from the center portion, excluding the region of the center core 13, to the outer circumference of the magnetic disk medium.

The magnetic disk driving section holds the magnetic disk cartridge 10 at a predetermined position and chucks the center core 13 which is holding the magnetic disk media 14 and 15 by the spindle shaft 35 and a hub chuck 36. A drive motor 37 drives the spindle shaft 35 and the hub chuck 36 to rotate the magnetic disk media 14 and 15 at a predetermined rotational speed.

When recording/reproducing signals on the magnetic disk medium, the magnetic disk medium is rotated at the predetermined rotation speed by the magnetic disk driving section. The magnetic heads 32 are inserted into the magnetic head insertion portion of the magnetic disk cartridge 10. The magnetic heads 32 are made to approach the magnetic disk medium which is on the lower side in the magnetic disk cartridge 10 inserted into the drive 30 to magnetically record or reproduce signals.

In the case where recording/reproducing signals on the magnetic disk medium which is on the upper side in the magnetic disk cartridge 10 inserted into the drive 30, the magnetic disk cartridge 10 is once removed from the drive 30 and flipped. Thereafter, the magnetic disk cartridge 10 is re-inserted into the drive 30 to record/reproduce signals on the magnetic disk medium which had been on the upper side before removal.

As described above, by containing two magnetic disk media in a housing, it is possible to double the recording capacity of a magnetic disk cartridge compared with a normal magnetic disk cartridge which contains only one magnetic disk medium, without enlarging an area of a flat surface of the cartridge.

Note that the manner in which two magnetic disk media are contained in a housing is not limited to the aspect of the embodiment described above. Moreover, the number of the magnetic disk media contained in the housing is not limited to that of the above description, and the housing may contain three or more magnetic disk media.

What is claimed is:

1. A magnetic disk cartridge comprising:
a rotatable magnetic disk medium;
a housing for containing the magnetic disk medium, provided with an opening portion for a recording/reproducing head of a recording/reproducing device to access the magnetic disk medium; and
a shutter member being movable so as to open and close the opening portion, the shutter member being moved by a shutter opening/closing member of the recording/reproducing device to a position at which the opening portion is opened, accompanying insertion of the magnetic disk cartridge into the recording/reproducing device,
wherein a plurality of magnetic disk media are contained in the housing, arranged so that their rotational centers are aligned.

2. A magnetic disk cartridge as defined in claim 1, wherein two magnetic disk media are contained in the housing.

3. A magnetic disk cartridge as defined in claim 1, wherein the plurality of magnetic disk media is integrally held by a single center core.

4. A magnetic disk cartridge as defined in claim 1, wherein the shutter member comprises a pair of shutter components provided for each magnetic disk medium to open and close the upper and lower surfaces thereof.

5. A magnetic disk cartridge as defined in claim 4, wherein one of each pair of the shutter components is provided with a shutter knob for opening and closing the shutter.

6. A magnetic disk cartridge as defined in claim 2 wherein the two magnetic disk media are integrally held by a single center core.

7. A magnetic disk cartridge as defined in claim 6, wherein each of the two magnetic disk media are provided with the shutter member, each shutter member comprising a pair of shutter components for opening and closing the upper and lower surfaces of each of the magnetic disk media.

8. A magnetic disk cartridge as defined in claim 7, wherein one of each pair of the shutter components is provided with a shutter knob for opening and closing the shutter.

9. A magnetic disk cartridge as defined in claim 8, further comprising an urging means for urging the shutter members to a position that closes the opening portion for the recording/reproducing head to access the magnetic disk media.

10. A recording/reproducing system comprising:
a magnetic disk cartridge comprising:
a housing having an opening portion to enable access by a head;
a plurality of magnetic disk media rotatably housed within the housing, arranged so that their rotational centers are aligned; and
a shutter member capable of moving between a position in which the opening portion is open and a position in which the opening portion is closed; and
a recording/reproducing apparatus comprising:
a recording/reproducing portion for performing recording and reproduction on and from at least one of the magnetic disk media; and
a magnetic disk driving portion for rotationally driving the magnetic disk media; wherein
the shutter members, which are in a position that closes the opening portion prior to insertion of the magnetic disk cartridge into the recording/reproducing apparatus, are caused to move to a position that opens the opening portion accompanying the insertion of the magnetic disk cartridge into the recording/reproducing apparatus.

11. A recording/reproducing system as defined in claim 10, wherein:
the shutter member of the magnetic disk cartridge comprises a pair of shutter components provided for each magnetic disk medium to open and close the upper and lower surfaces thereof;
a shutter knob for opening and closing the shutter is provided on one of each pair of shutter components; and
the recording/reproducing apparatus comprises a shutter opening/closing member for engaging the shutter knob, to move the shutter member to the open position accompanying the insertion of the magnetic disk cartridge into the recording/reproducing apparatus.

12. A recording/reproducing system as defined in claim 10, wherein:
the magnetic disk cartridge further comprises an urging means for urging the shutter members to a position that closes the opening portion; and
the shutter member is moved to an open position against the urging force of the urging means accompanying the insertion of the magnetic disk cartridge into the recording/reproducing apparatus.
